(19) United States
(12) Patent Application Publication
(10) Pub. No.: US 2021/0148157 A1
(43) Pub. Date: May 20, 2021

(54) Remote Controlled Lock Box Assembly

(71) Applicants: Guadalupe Muniz, Madera, CA (US); John Velarde, Madera, CA (US)

(72) Inventors: Guadalupe Muniz, Madera, CA (US); John Velarde, Madera, CA (US)

(21) Appl. No.: 16/689,237

(22) Filed: Nov. 20, 2019

(51) Int. Cl. E05G 1/04; E05B 65/00; E05B 47/00; E05B 17/22; H04N 7/18; G07C 9/00

(52) U.S. Cl. CPC E05G 1/04; E05B 65/0075; E05B 47/0001; G07C 2009/0019; H04N 7/185; G07C 9/00182; E05B 17/22

(57) ABSTRACT

A remote controlled lock box assembly includes a box that is positionable adjacent to a parcel delivery location for receiving a parcel. A lid is hingedly coupled to the box for opening and closing the box. A locking unit is coupled to the lid and the locking unit is actuatable into a locking condition and an unlocked condition. The locking unit is in wireless communication with a remote control such that the remote control actuates the locking unit between the locked condition and the unlocked condition. A video camera is coupled to the box to capture video footage of the parcel delivery location. The video camera is in remote communication with the remote control thereby facilitating the remote control to receive the video footage captured by the video camera.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lock box devices and more particularly pertains to a new lock box device for remotely securing a parcel.

### (2) Description of Related Art Including Information Disclosed Under 37 CFR 1.97 and 1.98

The prior art relates to lock box devices. The prior art discloses a variety of lock boxes for securing a parcel. The prior art includes combination locks and keyed locks, and in several cases the combination locks are electronic locks. The prior art discloses an electronic lock that would have a pre-determined code entered therein to open the box. The pre-determined code would be entered by the delivery person and by the owner of the box. None of the prior art disclosed includes a surveillance camera in conjunction with a remotely controlled lock.

### BRIEF SUMMARY OF THE INVENTION

An embodiment of the disclosure meets the needs presented above by generally comprising a box that is positionable adjacent to a parcel delivery location for receiving a parcel. A lid is hingedly coupled to the box for opening and closing the box. A locking unit is coupled to the lid and the locking unit is actuatable into a locking condition and an unlocked condition. The locking unit is in wireless communication with a remote control such that the remote control actuates the locking unit between the locked condition and the unlocked condition. A video camera is coupled to the box to capture video footage of the parcel delivery location. The video camera is in remote communication with the remote control thereby facilitating the remote control to receive the video footage captured by the video camera.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a remote controlled lock box assembly according to an embodiment of the disclosure.

FIG. 2 is a back phantom view of an embodiment of the disclosure.

FIG. 3 is a right side view of an embodiment of the disclosure.

FIG. 4 is a front view of an embodiment of the disclosure showing a large sized box.

FIG. 5 is a front view of an embodiment of the disclosure showing a medium sized box.

FIG. 6 is a front view of an embodiment of the disclosure showing a small sized box.

FIG. 7 is a bottom view of an embodiment of the disclosure.

FIG. 8 is a schematic view of an embodiment of the disclosure.

### DETAILED DESCRIPTION OF THE INVENTION

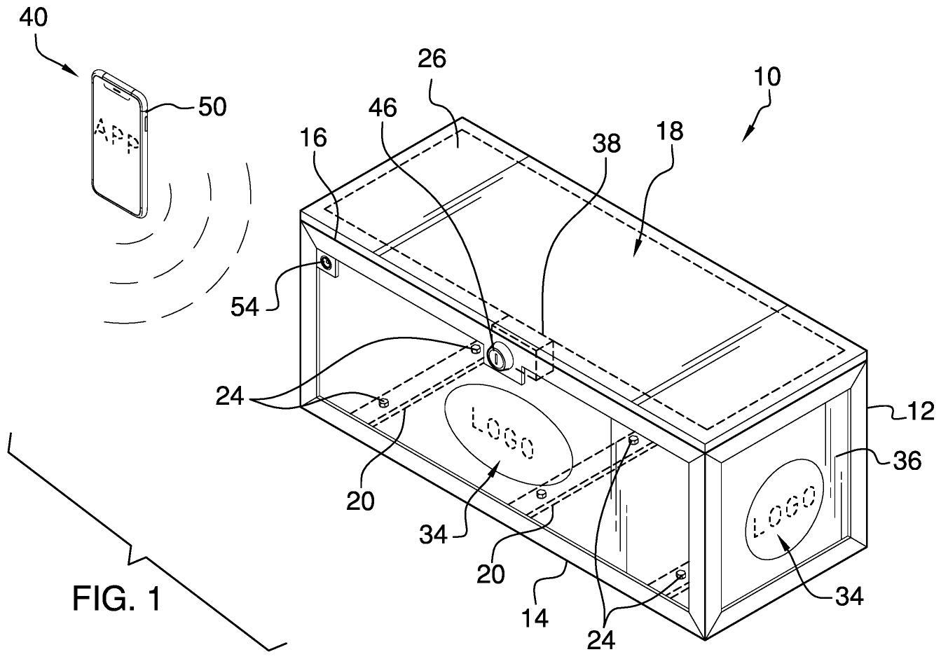

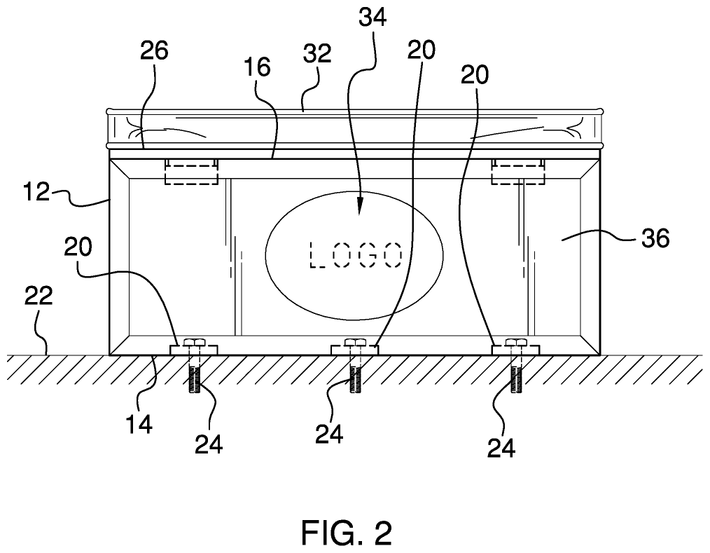

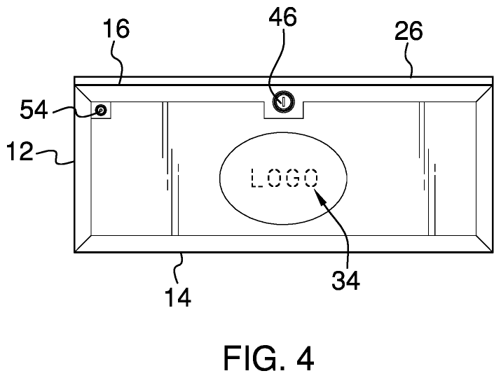

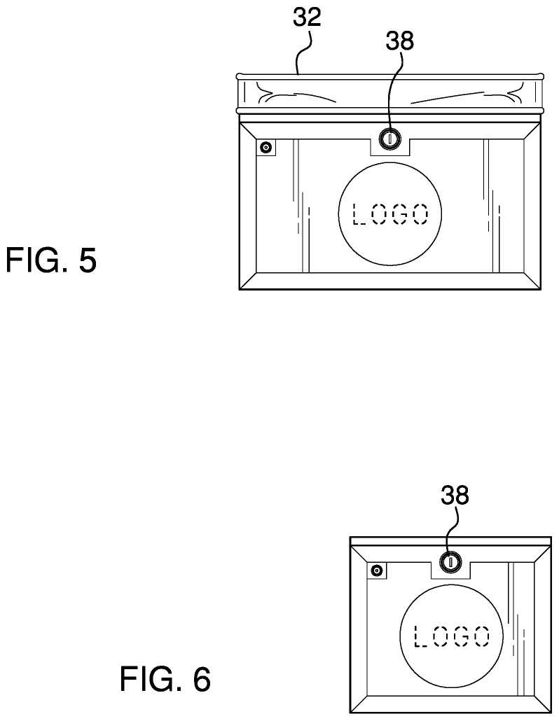

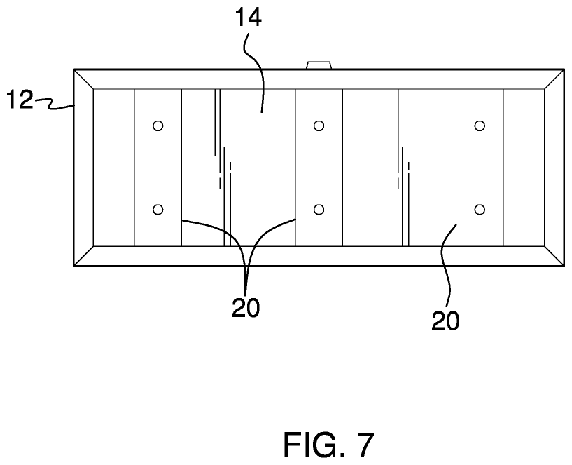

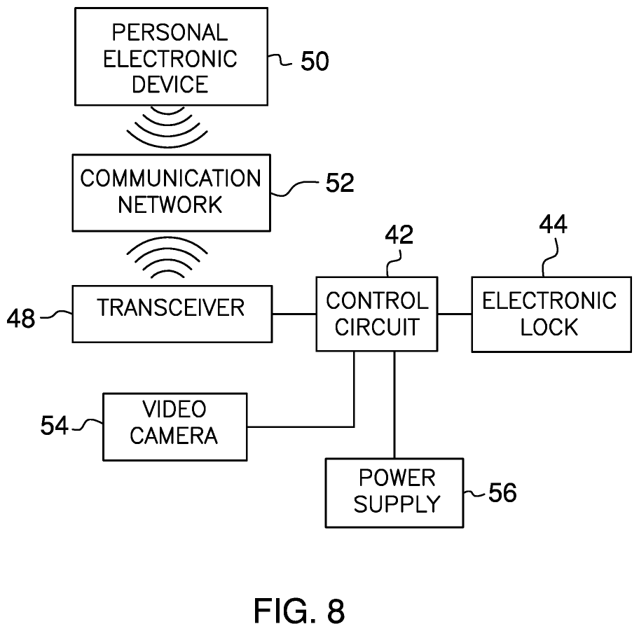

With reference now to the drawings, and in particular to FIGS. 1 through 8 thereof, a new lock box device embodying the principles and concepts of an embodiment of the disclosure and generally designated by the reference numeral 10 will be described.

As best illustrated in FIGS. 1 through 8, the remote controlled lock box assembly 10 generally comprises a box 12 that is positionable adjacent to a parcel delivery location. Thus, the box 12 is accessible to a delivery person. The box 12 has a bottom wall 14 and a top edge 16 defining an opening 18 into the box 12. The bottom wall 14 has a plurality of reinforcements 20 thereon and the bottom wall 14 rests on a support surface 22. The box 12 is comprised of a rigid material, including but not being limited to, steel. The box 12 may have a width ranging between approximately 24.0 inches and 50.0 inches, a depth ranging between approximately 20.0 inches and 30.0 inches and a height ranging between approximately 50.0 inches and 30.0 inches.

A plurality of fasteners 24 is provided and each of the fasteners 24 is extendable through a respective one of the reinforcements 20 on the bottom wall 14. Each of the fasteners 24 engages the support surface 22 to fasten the box 12 to the support surface 22. Additionally, each of the fasteners 24 may comprise a bolt or other type of threaded fastener.

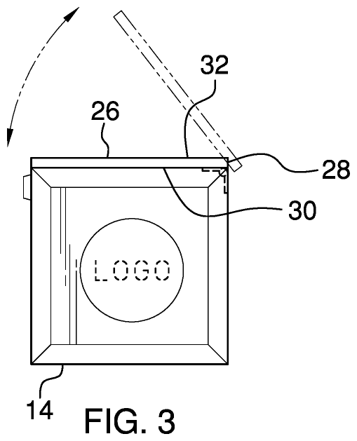

A lid 26 is hingedly coupled to the box 12 for opening 18 and closing the box 12. The lid 26 has a rear edge 28, a lower surface 30 and a top surface 32. The rear edge 28 is coupled to the top edge 16 of the box 12 and the lower surface 30 rests on the top edge 16 when the lid 26 is closed. A cushion 32 is positioned on the lid 26 thereby facilitating the cushion 32 to be sat upon. The cushion 32 is comprised of a resiliently compressible material to enhance comfort for sitting thereon. Indicia 34 may be printed on an outer wall 36 of the box 12 and the indicia 34 may comprise a logo, an image or any other chosen indicia. As is most clearly shown in FIG. 3, hinges associated with the lid 26 are positioned inside the box 12 thereby inhibiting the lid 26 from being removed from the box 12.

A locking unit 38 is coupled to the lid 26 and the locking unit 38 is actuatable into a locking condition and an unlocked condition. The lid 26 can be opened when the locking unit 38 is in the unlocked condition thereby facilitating a parcel to be delivered into the box 12. The lid 26 is inhibited from being opened when the locking unit 38 is in the locked condition. In this way the box 12 secures the parcel. The locking unit 38 is in wireless communication with a remote control 40 such that the remote control 40 actuates the locking unit 38 between the locked condition and the unlocked condition.

The locking unit 38 comprises a control circuit 42 that is coupled to the box 12. The control circuit 42 receives a lock input and an unlock input. An electronic lock 44 is coupled to the bottom surface of the lid 26 and the electronic lock 44 is electrically coupled to the control circuit 42. The electronic lock 44 is turned on the engage the box 12 when the control circuit 42 receives the lock input for locking the lid 26. Conversely, the electronic lock 44 is turned off to disengage the box 12 for unlocking the lid 26. The electronic lock 44 includes a keyhole 46 extending outwardly through the box 12 and the keyhole 46 insertably receives a key for manually locking and unlocking the lid 26. The electronic lock 44 may include an actuator and a bolt that is coupled to the actuator or any other electro mechanical lock.

A transceiver 48 is coupled to the box 12, the transceiver 48 is electrically coupled to the control circuit 42 and the transceiver 48 is in wireless communication with a personal electronic device 50. The transceiver 48 receives an unlock command or a lock command from the personal electronic device 50. The control circuit 42 receives the unlock input when the transceiver 48 receives the unlock command. Additionally, the control circuit 42 receives the lock input when the transceiver 48 receives the lock command.

The transceiver 48 may comprise a radio frequency transceiver and the transceiver 48 may employ a WPAN signal. The transceiver 48 is in communication with a communication network 52, such as a wifi internet router or the like, thereby facilitating the transceiver 48 to communicate with the personal electronic device 50 regardless of the distance between the personal electronic device 50 and the box 12. The personal electronic device 50 may comprise a smart phone or other type of electronic device that has wireless communication capabilities. The personal electronic device 50 may store operational software, such as smart phone app, for remotely controlling the electronic lock 44.

A video camera 54 is coupled to the box 12 to capture video footage of the parcel delivery location. The video camera 54 is in remote communication with the remote control 40 thereby facilitating the remote control 40 to receive the video footage captured by the video camera 54. In this way an owner of the box 12 can verify the identity of an individual attempting to open the box 12. The video camera 54 is positioned on the outer wall 36 of the box 12 and the video camera 54 is electrically coupled to the control circuit 42. The video camera 54 may comprise a digital video camera of any conventional design and the personal electronic device 50 may display the video footage. A power supply 56 is coupled to the box 12, the power supply 56 is electrically coupled to the control circuit 42 and the power supply 56 comprises at least one battery.

In use, the owner of the box 12 is alerted by the video camera 54 when an individual approaches the box 12. The owner can subsequently turn off the electronic lock 44 to facilitate the individual to open the lid 26 and deposit a parcel in the box 12. The owner can turn on the electronic lock 44 after the parcel is deposited in the box 12 and the lid 26 is closed. In this way the parcel is secured until the owner of the box 12 is able to retrieve the parcel from the box 12. The lid 26 cannot be opened unless the owner of the box 12 turns off the electronic lock 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remote controlled lock box assembly being configured to be remotely locked and unlocked for receiving and securing a parcel, said assembly comprising:
a box being positionable adjacent to a parcel delivery location wherein said box is configured to be accessible to a delivery person;
a lid being hingedly coupled to said box for opening and closing said box;
a locking unit being coupled to said lid, said locking unit being actuatable into a locking condition and an unlocked condition, said lid being facilitated to be opened when said locking unit is in said unlocked condition wherein said box is configured to have a parcel positioned therein, said lid being inhibited from being opened when said locking unit is in said locked condition wherein said box is configured to secure the parcel, said locking unit being in wireless communication with a remote control such that said remote control actuates said locking unit between said locked condition and said unlocked condition; and
a video camera being coupled to said box wherein said video camera is configured to capture video footage of the parcel delivery location, said video camera being in remote communication with the remote control thereby facilitating the remote control to receive the video footage captured by said video camera wherein said video camera is configured to verify the identity of an individual attempting to open said box for an owner of said box.

2. The assembly according to claim 1, wherein:
said box has a bottom wall and a top edge defining an opening into said box, said bottom wall having a plurality of reinforcements thereon, said bottom wall resting on a support surface;
said assembly includes a plurality of fasteners, each of said fasteners being extendable through a respective one of said reinforcements on said bottom wall and engaging the support surface to fasten said box to the support surface; and
said lid has a rear edge, a lower surface and a top surface, said rear edge being coupled to said top edge of said box, said lower surface resting on said top edge when said lid is closed.

3. The assembly according to claim 1, wherein said locking unit comprises a control circuit being coupled to said box, said control circuit receiving a lock input and an unlock input.

4. The assembly according to claim 3, further comprising an electronic lock being coupled to said bottom surface of said lid, said electronic lock being electrically coupled to said control circuit, said electronic lock being turned on to engage said box when said control circuit receives said lock input for locking said lid, said electronic lock being turned off to disengage said box for unlocking said lid.

5. The assembly according to claim 4, further comprising said electronic lock includes a keyhole extending outwardly through said box, said keyhole insertably receiving a key for manually locking and unlocking said lid.

6. The assembly according to claim 4, further comprising a transceiver being coupled to said box, said transceiver being electrically coupled to said control circuit, said transceiver being in wireless communication with a personal electronic device, said transceiver receiving an unlock command or a lock command from the personal electronic device, said control circuit receiving said unlock input when said transceiver receives the unlock command, said control circuit receiving said lock input when said transceiver receives the lock command.

7. The assembly according to claim 3, wherein said video camera is positioned on an outer wall of said box, said video camera being electrically coupled to said control circuit.

8. The assembly according to claim 3, further comprising a power supply being coupled to said box, said power supply being electrically coupled to said control circuit, said power supply comprising at least one battery.

9. A remote controlled lock box assembly being configured to be remotely locked and unlocked for receiving and securing a parcel, said assembly comprising:
a box being positionable adjacent to a parcel delivery location wherein said box is configured to be accessible to a delivery person, said box having a bottom wall and a top edge defining an opening into said box, said bottom wall having a plurality of reinforcements thereon, said bottom wall resting on a support surface;
a plurality of fasteners, each of said fasteners being extendable through a respective one of said reinforcements on said bottom wall and engaging the support surface to fasten said box to the support surface;
a lid being hingedly coupled to said box for opening and closing said box, said lid having a rear edge, a lower surface and a top surface, said rear edge being coupled to said top edge of said box, said lower surface resting on said top edge when said lid is closed;
a cushion being positioned on said lid wherein said cushion is configured to be sat upon, said cushion being comprised of a resiliently compressible material wherein said cushion is configured to enhance comfort for sitting thereon
a locking unit being coupled to said lid, said locking unit being actuatable into a locking condition and an unlocked condition, said lid being facilitated to be opened when said locking unit is in said unlocked condition wherein said box is configured to have a parcel positioned therein, said lid being inhibited from being opened when said locking unit is in said locked condition wherein said box is configured to secure the parcel, said locking unit being in wireless communication with a remote control such that said remote control actuates said locking unit between said locked condition and said unlocked condition, said locking unit comprising:
a control circuit being coupled to said box, said control circuit receiving a lock input and an unlock input;
an electronic lock being coupled to said bottom surface of said lid, said electronic lock being electrically coupled to said control circuit, said electronic lock being turned on the engage said box when said control circuit receives said lock input for locking said lid, said electronic lock being turned off to disengage said box for unlocking said lid, said electronic lock including a keyhole extending outwardly through said box, said keyhole insertably receiving a key for manually locking and unlocking said lid;
a transceiver being coupled to said box, said transceiver being electrically coupled to said control circuit, said transceiver being in wireless communication with a personal electronic device, said transceiver receiving an unlock command or a lock command from the personal electronic device, said control circuit receiving said unlock input when said transceiver receives the unlock command, said control circuit receiving said lock input when said transceiver receives the lock command;
a video camera being coupled to said box wherein said video camera is configured to capture video footage of the parcel delivery location, said video camera being in remote communication with the remote control thereby facilitating the remote control to receive the video footage captured by said video camera wherein said video camera is configured to verify the identity of an individual attempting to open said box for an owner of said box, said video camera being positioned on an outer wall of said box, said video camera being electrically coupled to said control circuit; and
a power supply being coupled to said box, said power supply being electrically coupled to said control circuit, said power supply comprising at least one battery.
